(19) United States
(12) Patent Application Publication
(10) Pub. No.: US 2022/0172233 A1
(43) Pub. Date: Jun. 2, 2022

(54) LOAD FORECASTING FROM INDIVIDUAL CUSTOMER TO SYSTEM LEVEL

(71) Applicant: Autogrid Systems, Inc., Redwood Shores, CA (US)

(72) Inventors: Amit NARAYAN, Cupertino, CA (US); Scott Christopher LOCKLIN, Berkeley, CA (US); Vijay Srikrishna BHAT, San Francisco, CA (US); Henry SCHWARZ, Foster City, CA (US)

(73) Assignee: Autogrid Systems, Inc., Redwood Shores, CA (US)

(21) Appl. No.: 17/368,744

(22) Filed: Jul. 6, 2021

Related U.S. Application Data
(63) Continuation of application No. 14/345,235, filed on Oct. 13, 2014, now abandoned.
(60) Provisional application No. 61/535,946, filed on Sep. 17, 2011.
(60) Provisional application No. 61/535,949, filed on Sep. 17, 2011.

(51) Int. Cl. G06Q 30/02; G06Q 10/06; H02J 3/00; G06Q 50/06

(52) U.S. Cl. CPC G06Q 30/0202; G06Q 10/06; H02J 3/008; H02J 3/003; G06Q 50/06; Y04S 50/10; Y04S 50/14; G06Q 30/0204

(57) ABSTRACT

The present invention relates to system and method for providing near real-time DR events and price signals to the customer end-points to optimally manage the available DR resources. The system utilizes bottom up load forecasting for accurate individualized forecasts for customer loads in the presence of dynamic pricing signals. For better efficiency and reliability of grid operation the system utilizes advanced machine learning and robust optimization techniques for real-time and “personalized” DR-offer dispatch.

### CROSS-REFERENCE TO RELATED APPLICATION(S)

This application claims the benefit of priority to U.S. Provisional Patent Application No. 61/535,949, filed Sep. 17, 2011, entitled “Bottom-up Load Forecasting from Individual Customer to System-Level Based on Price” and claims the benefit of priority to U.S. Provisional Patent Application No. 61/535,946, filed Sep. 17, 2011, entitled “Machine Learning Applied to Smart Meter Data to Generate User Profiles—Specific Algorithms”, the contents of each of which are hereby incorporated by reference in their entireties.

### FIELD OF THE INVENTION

The present invention relates generally to load forecasting, and more particularly to bottom-up load forecasting from individual customer to system level based on price.

### BACKGROUND

Accurate models for electric power load forecasting are essential for the operation and planning of a utility company. Load forecasting helps an electric utility company to make important decisions including decisions on purchasing and generating electric power, load switching, and infrastructure development. Load forecasts are extremely important for energy suppliers, ISOs, financial institutions, and other participants in electric energy generation, transmission, distribution, and markets. Load forecasts can be divided into three categories: short-term forecasts which are usually from one hour to one week, medium forecasts which are usually from a week to a year, and long-term forecasts which are longer than a year.

End-use or bottom up approach is used for generating medium term forecasting. Bottom up approach directly estimates energy consumption by using extensive information on end use and end users, such as appliances, the customer use, their age, sizes of houses, and so on. These models focus on the various uses of electricity in the residential, commercial, and industrial sector. These models are based on the principle that electricity demand is derived from customer's demand for light, cooling, heating, refrigeration, etc. Thus, end-use or bottom up models explain energy demand as a function of the number of appliances and the level of energy service demanded or work demand from each appliance or system.

For load forecasting several factors should be considered, such as time factors, weather data, possible customer's classes, price signals, the historical load and weather data, the number of customers in different categories, the appliances in the area and their characteristics including age, the economic and demographic data and their forecasts, the appliance sales data, and other factors.

Recently, price signals are being considered for load forecasting. A price signal is a message sent to consumers and producers in the form of a price charged for a commodity; this is seen as indicating a signal for producers to increase supplies and/or consumers to reduce demand. However, existing load forecasting systems were not able to do accurate individualized forecast for customer loads in the presence of dynamic price signals due to lack of usage information at the end customer level.

In light of the foregoing discussion, forecasting algorithms were needed that could account for individual customer price elasticity during load forecasting.

### ABBREVIATION AND DEFINITION

DROMS-RT: Demand Response Optimization and Management System for Real-Time

DR: Demand Response

FE: Forecasting Engine

ML: Machine Learning

BE: Baseline Computation and Settlement Engine

KNN: K-nearest Neighbor

SVM: Support Vector Machine

DROMS-RT: DROMS-RT is a highly distributed demand response optimization and management system for real-time power flow control to support large scale integration of distributed generation into the grid.

Demand Response (DR): Demand Response (DR) is a mechanism to manage customer consumption of electricity in response to supply conditions. DR is generally used to encourage consumers to reduce demand, thereby reducing the peak demand for electricity.

Forecasting Engine (FE): Forecasting Engine (FE) gets the list of available resources from the resource modelers; its focus is to perform short-term forecasts of aggregate load and available load-sheds for individual loads connected to DROMS-RT.

Machine Learning (ML): Machine learning (ML) is a subset of artificial intelligence, and is concerned with the design and development of algorithms that allow computers to evolve behavior based on the data received from sensors and databases. Machine learning techniques involve online learning which learn one instance at a time.

Baseline Computation and Settlement Engine (BE): Baseline Computation and Settlement Engine (BE) uses signal processing techniques to identify even small systematic load sheds in the background of very large base signals.

K-nearest Neighbor (KNN): A memory-based technique where forecasts are generated by looking at the observed loads for similar cases in the historical data.

Support Vector Machine (SVM): It is a curve fitting technique that is relatively immune to noise, and can robustly model non-linear relationships in the data by transforming the raw data to higher dimensions.

### SUMMARY OF THE INVENTION

Accordingly in an aspect of the present invention a method for individualized forecast for customer load in presence of dynamic pricing signals and optimal dispatch of DR resources across a large portfolio of heterogeneous load in a demand response management system is provided. The method comprises of keeping a unified view of available demand side resources under all available DR programs; recording history of participation in different DR events at individual customer locations in a storing database; segmenting the demand response specific data in a number of time series that are related to each other; building a self-calibrated model for each customer using historical time series data; collecting periodic electricity usage data at individual customer location; predicting the changes in customer load profile by getting feedback from load time series of individual customers; forecasting individual customer load usage and load shed as well as error distribution associated with forecast using machine learning and data mining techniques; getting continuous feedback from the client device to increase the ability to forecast; dispatching the DR signals across a portfolio of customers based on the forecasts dependent on a cost function.

In another aspect of the present invention a method for individualized forecast for customer forecast in presence of dynamic price signals is provided. The method comprises of a storing database for collecting periodic electricity usage data at individual customer level using advance metering data and sensors on distribution grid; aggregating the customer level data at transformer, feeder and sub-station level; creating a profile of electric load for individual customer on the basis of customer price elasticity estimated using a plurality of machine learning techniques; an open source software framework to support the multiple machine learning models; segmenting the individual customer load and usage data in time series using machine learning models; producing short-term forecast for individual customer load and aggregated power load as well as the error distribution associated with the forecast.

### BRIEF DESCRIPTION OF THE DRAWINGS

The preferred embodiment of the invention will hereinafter be described in conjunction with the appended drawings provided to illustrate and not to limit the scope of the invention, wherein like designation denote like element and in which:

FIG. 1 is a block diagram illustrating the operation of demand response optimization and management system for real time (DROMS-RT) in accordance with an embodiment of the present invention.

FIG. 2 is a user interface showing the available demand side resources under all available DR programs in accordance with an embodiment of the present invention.

FIG. 3 user interface showing available demand side resources under all available DR programs and history of participation in different DR events at individual customer locations in accordance with an embodiment of the present invention.

FIG. 4 is a is a user interface showing the forecast for individual customer load and aggregated power load in accordance with an embodiment of the present invention.

FIG. 5 is a quick back-of-the-envelope calculation for the size of the data in accordance with an embodiment of the present invention.

FIG. 6 is a schematic representation of dynamic demand response (DR) resource model inputs and portfolio of dynamic demand response (DR) resources in accordance with an embodiment of the present invention.

### DETAILED DESCRIPTION OF THE EMBODIMENTS

In the following detailed description of embodiments of the invention, numerous specific details are set forth in order to provide a thorough understanding of the embodiment of invention. However, it will be obvious to a person skilled in art that the embodiments of invention may be practiced without these specific details. In other instances well known methods, procedures and components have not been described in detail so as not to unnecessarily obscure aspects of the embodiments of the invention.

Furthermore, it will be clear that the invention is not limited to these embodiments only. Numerous modifications, changes, variation, substitutions and equivalents will be apparent to those skilled in the art without parting from the spirit and scope of the invention.

DROMS-RT is a highly distributed Demand Response Optimization and Management System for Real-Time power flow control to support large scale integration of distributed generation into the grid.

Bottom-up load forecasting based on price is a technique that uses the DROMS-RT system to forecast a model that takes into account customer specific behavior and is able to predict the change in load profile due to the use of specific strategies that the customer might be using to shift the load from a period of high prices to low prices. DROMS-RT automatically selects the mix of DR resources best suited to meet the needs of the grid.

Bottom-up load forecasting based on price uses DROMS-RT algorithm for accurate individualized forecasts for customer loads in the presence of dynamic pricing signals. Dynamic pricing signals include price based DR for load forecasting to shift peak load, target loads within subLAPS (load aggregation points) and enable valuable management of congestion constrained electric grids with subLAP (load aggregation point) granularity by increasing the overall peak demand.

For the purpose of load forecasting, the DROMS-RT provides near real-time DR events and price signals to the customer end-points to optimally manage the available DR resources. It uses shelf information and communication technology and controls equipment for DR purposes. For better efficiency and reliability of grid operation DROMS-RT utilizes advanced machine learning and robust optimization techniques for real-time and “personalized” DR offer dispatch.

In bottom-up load forecasting, DROMS-RT will keep a unified view of available demand side resources under all available DR programs and history of participation in different DR events at individual customer locations. The DR resource models will be dynamic, meaning they will vary based on current conditions and various advanced notice requirements. It uses historical time series data from the past participation to build a self-calibrated model for each customer that will be able to forecast shed capacity, ramp time and rebound effects for that customer given the time-of-day, weather and price signal.

The present invention relates to a system and a method for bottom-up load forecasting from individual customer to system-level based on price by utilizing DROMS-RT's forecasting algorithm that accounts for individual customer price elasticity during load forecasting. The DROMS-RT load forecast model also takes into account customer specific behavior and is able to predict the change in load profile due to the use of specific strategies that the customer might be using to shift the load from a period of high prices to low prices. Such strategies may include pre-cooling a building in anticipation of high prices to reduce the usage during the higher priced events. Such strategies are implicitly ‘learned’ from the load time-series of individual customers using machine learning algorithm.

The DROMS-RT load forecast algorithm can predict effects of customer fatigue when the high price events happen repeatedly, back-to-back or if they are too long, by looking at the customer load data. The availability of the individual load forecasts also improves the overall accuracy of the system-level load forecast by combining many different bottom-up sources of data.

Advanced Metering Infrastructure (AMI) and other types of sensors on the distribution grid are used for collecting periodic electricity usage data at an individual customer level and the collected data is aggregated at the transformer, feeder and sub-station level. The DROMS-RT system proposes to utilize this AMI meter data and other data collected at the transformer or the appliance level to forecast individual customer usage using machine learning and time-series data mining techniques.

In an embodiment of the present invention, the system is comprised of a novel forecasting engine based on modern online machine learning algorithms that is designed to enable accurate individualized forecasts for customer loads in the presence of dynamic pricing signals, and a real-time decision engine will enable continuous optimization and optimal dispatch of DR resources across a large portfolio of heterogeneous loads that respond at varying time-scales.

The individual time-series of customer load and usage data is used to produce short-term forecasts for individual customer loads as well as aggregated power load which is based on sums of forecasts of individual customers. In addition, by creating forecasts of individual customers, the utility company will be in a better position to anticipate and geographically pinpoint load imbalances and can take actions to mitigate such imbalances with greater accuracy and efficiency.

Clustering techniques are used to segment the data into time series that are associated with one another. The segmentation of demand response specific data is carried out on the basis of seasonality, time of occurrence, price index, temperature and other regression parameters and the segmenting techniques or clustering techniques used for segmenting the demand response event specific data includes K-mean and fuzzy K-means algorithms. Segmentation of the time series may also take place within a given time series.

Machine learning techniques are used for generating accurate forecasts of baseline loads and load sheds in the presence of demand response events, estimates of error distributions, distributing massive amount of data, self learning and improving the forecast accuracy. The Demand Response Optimization and Management System for Real-Time (DROMS-RT) stores available demand side resources and history of participation in different demand response (DR) events at individual user locations in a storing database such as MonetDB, KDB, or Xenomorph. By using this information a virtual profile for each user can be built that is able to forecast the load shed, shed duration, and reverse effects for that user provided the time of day, weather and price signals are known. These profiles are random in nature and capture the individual user variances.

The machine learning model includes ARIMAX model, memory-based machine learning models such as K-nearest neighbor, fitted machine/connectionist learning models such as support vector machine or artificial neural nets and the storing database includes MonetDB, KDB, Xenomorph. The ARIMAX model can be built for forecasting and characterization of customer response to demand response signals with the grid using the clustered load data time series. SVM or artificial neural network techniques are built to produce accurate results in cases where there is much data, a situation that fits the DROMS-RT problem very well.

Massively parallel implementations involving Hadoop/Map-Reduce will be deployed to handle terabytes of data and millions of data streams simultaneously. Time-series databases and machine learning algorithms uses massively parallel and distributed computation paradigm for handling large data using dimensionality reduction.

The time series are multi-seasonal on at least three levels that include time of day, day of week, and day of year seasonality, as well as customer price sensitivity to scheduled demand response (DR) events. DROMS-RT, by providing a unified view of all DR resources across all programs and optimally dispatching these resources will make the system significantly more efficient. This efficiency gain will bring down the cost of electricity for customers and will further spur adoption of the technology causing a powerful positive feedback loop.

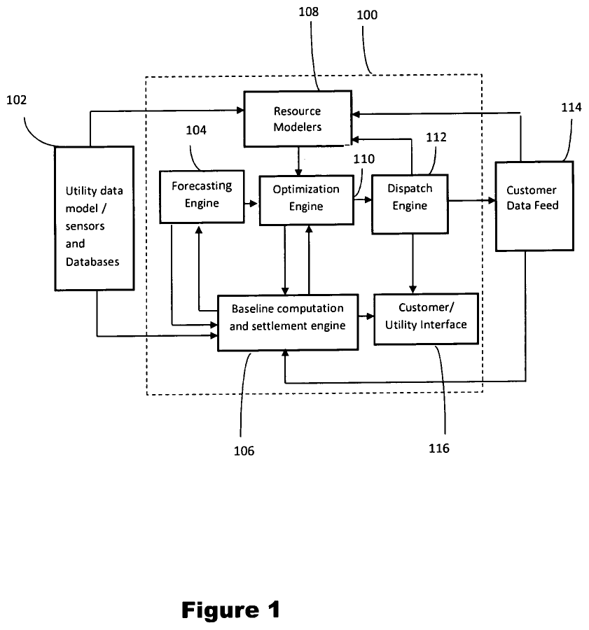

FIG. 1 is a schematic representation showing the operation of demand response optimization and management system for real time in accordance with an embodiment of the present invention. Referring to FIG. 1, a demand response optimization and management system for real time (DROMS-RT) 100 is provided. The system 100 comprising: a Forecasting Engine 104, a Baseline Engine 106, a Resource Modeler 108, an Optimizer 110, and a Dispatch Engine 112. The system 100 is coupled to the utility's backend data system 102 on one side and customer end-points 114 on the other side.

The system provides near real time DR event and price signals to the customer end points to optimally manage the available DR resources. The DR Resource Modeler (DRM) 108 within the system 100 keeps track of all the available DR resources, their types, their locations and other relevant characteristics such as response times, ramp-times etc. The Forecasting Engine (FE) 104 gets the list of available resources from the DR Resource Modeler 108. The focus of the Forecasting Engine 104 is to perform short-term forecasts of aggregate load and available load-sheds for individual loads connected to the system 100. The Optimizer 110 takes the available resources and all the constraints from the DR Resource Modeler 108 and the forecasts of individual loads and load-sheds and error distributions from the Forecasting Engine 104 to determine the optimal dispatch of demand response under a given cost function. The Baseline Engine 106 uses signal processing techniques to identify even small systematic load sheds in the background of very large base signals. The system 100 is coupled to customer data feed 114 on one side for receiving live data-feeds from customer end-devices. The system is coupled to utility data feed 102 on another side and the data from the utility data feed 102 is provided to calibrate the forecasting and optimization models to execute demand response events. The system 100 has a Dispatch Engine 112 that helps in taking decision and uses these resource specific stochastic models to dispatch demand response signals across a portfolio of customers to generate ISO bids from demand response or to optimally dispatch demand response signals to the customer based on the cleared bids and other constraints of the grid. The system uses customer/utility interface 116 connected to baseline engine 108 that provides an interface between the system and customer or the utility.

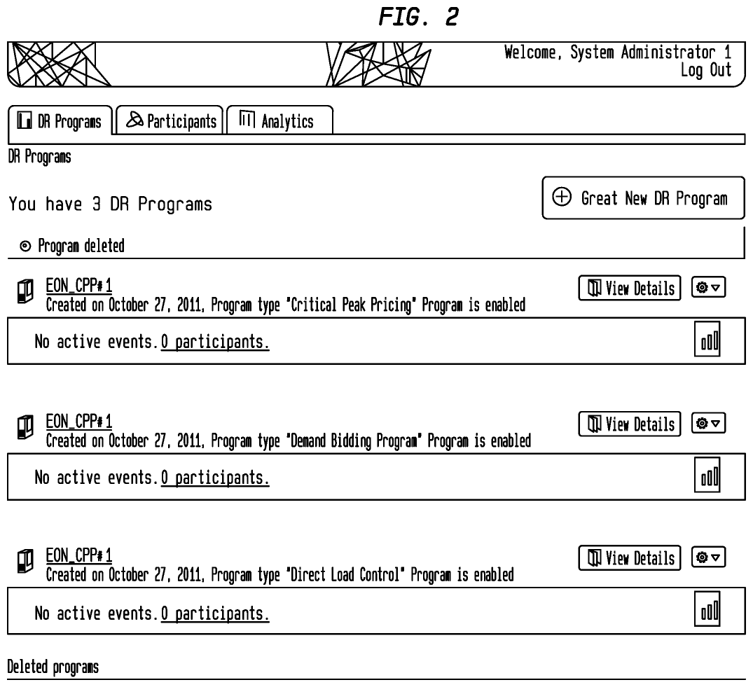

FIG. 2 is a user interface showing the available demand side resources under all available DR programs in accordance with an embodiment of the present invention. In practice, of course, some of the feeds might not be available all the time or in real-time; the Forecasting Engine 104 is also able to run in an “off-line” manner or with partial data feeds in these cases. The goal of the system 100 is to provide near real-time demand response event and price signals to the customer end-points to optimally manage the available demand response resources.

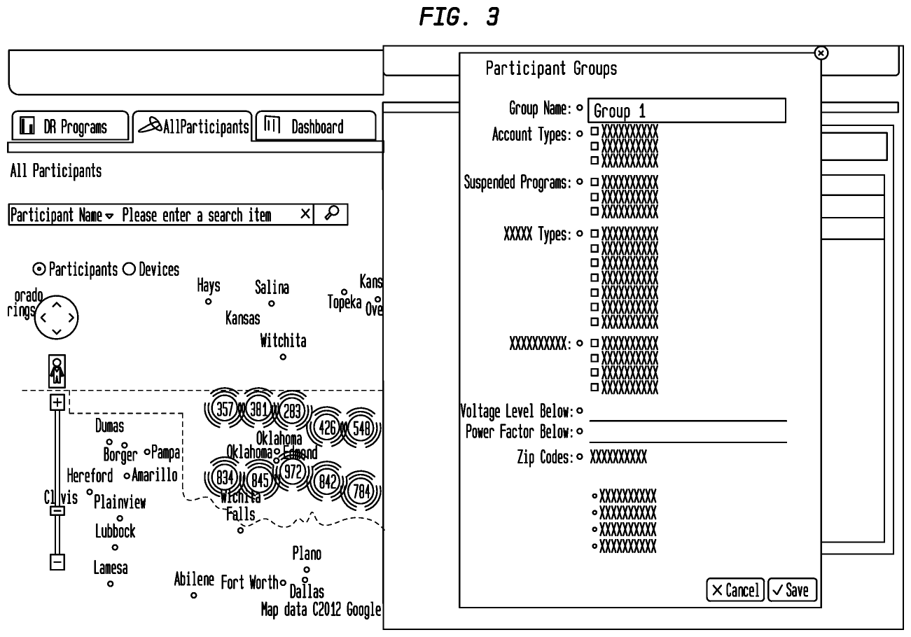

FIG. 3 is a user interface showing available demand side resources under all available DR programs and history of participation in different DR events at individual customer locations in accordance with an embodiment of the present invention.

The DR Resource Modeler 108 continuously updates the availability of resources affected by commitment to or completion of an event. The DR Resource Modeler 108 also monitors the constraints associated with each resource such as the notification time requirements, number of events in a particular period and number of consecutive events. It can also monitor user preferences to determine a “loading order” as to which resources are more desirable for participation in demand response events from a customer's perspective, and the contract terms the price at which a resource is willing to participate in an event. The demand response Resource Modeler 108 also gets a data feed from the client to determine whether the client is “online” (i.e. available as a resource) or has opted-out of the event.

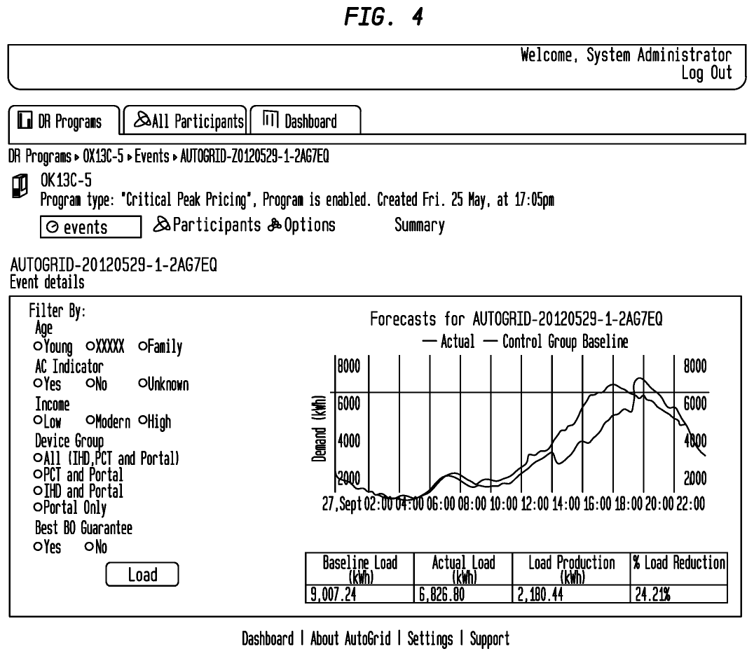

FIG. 4 is a user interface showing the forecast for individual customer load and aggregated power load in accordance with an embodiment of the present invention. The Forecasting Engine 104 accounts for a number of explicit and implicit parameters and applies machine learning (ML) techniques to derive short-term load and shed forecasts as well as error distributions associated with these forecasts. The Forecasting engine 104 provides baseline samples and the error distribution to the Baseline Engine 106. In addition, the Baseline Engine 106 gets the data feeds from the meter which is the actual power consumption data.

The Forecasting Engine 104 provides baseline samples and the error distribution to the BE engine 106. BE engine 106 uses signal processing techniques to identify even small systematic load sheds in the background of very large base signals and verifies whether a set of customers have all met their contractual obligation in terms of load-sheds. The BE 106 uses ‘event detection’ algorithm to determine if the load actually participated in the DR event, and if so, what the demand reduction due to that event was. The BE engine 106 feeds data back to the Forecasting Engine (FE) 104 so that it can be used to improve the baseline forecast. The Forecasting Engine 104 can also update the demand resource modeler (DRM) 104 about the load preferences by implicitly learning what type of decisions the client devices are making to the DR event offers.

The Optimization Engine (OE) 110 takes the available resources and all the constraints from the DRM (Demand Resource Modeler) 104 and the forecasts of individual loads and load-sheds and error distributions from the FE 104 to determine the optimal dispatch 112 of DR under a given cost function. OE 110 can incorporate a variety of cost functions such as cost, reliability, loading order preference, GHG or their weighted sum and can make optimal dispatch decisions over a given time-horizon that could cover day-ahead and near real-time horizons simultaneously. The system 100 will be able to automatically select the mix of DR resources best suited to meet the needs of the grid such as peak load management, real-time balancing, regulation and other ancillary services. The OE 110 can also be used to generate bids for wholesale markets given the information from DRM 104, and the wholesale market price forecasts that can be supplied externally.

The Dispatch Engine 112 dispatches the optimal demand response (DR) services in timeframes suitable for providing ancillary services to the transmission grid.

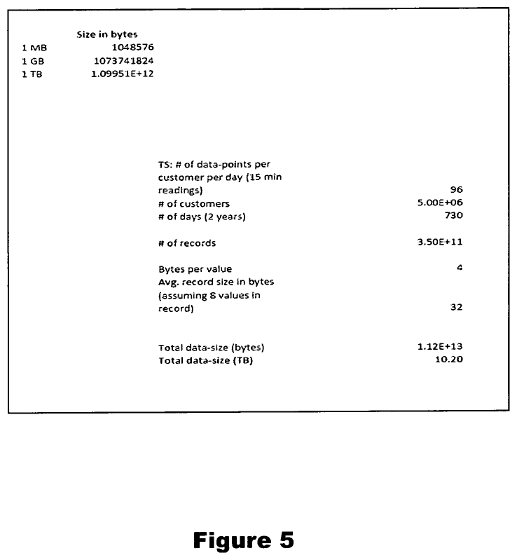

FIG. 5 is a quick back-of-the-envelope calculation for the size of the data. Referring to FIG. 5, the DROMS-RT Forecasting Engine (FE) 106 produces short-term forecasts for individual customer loads as well as aggregated power load, based on sums of forecasts of individual customers. While the availability of the individual customer data should provide more accurate results, the sheer size of the data makes for interesting engineering challenges. A quick back-of-the-envelope calculation for the size of the data shows that it can grow up to several petabytes with only a few million smart meters collecting 15-minute interval data.

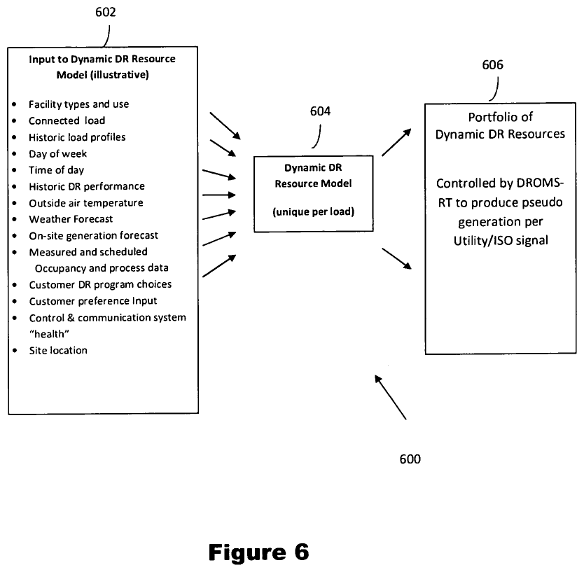

FIG. 6 illustrates dynamic DR Resource Model inputs and portfolio of dynamic DR resources in accordance with an embodiment of the present invention. The figure illustrates the various inputs to the dynamic demand response resource model 602 that are input to dynamic demand response resource model (unique per load) 604 and portfolio of dynamic demand response resources 606 controlled by the demand response optimization and management system for real time to produce pseudo generation per utility/ISO signal.

The DR Resource model 604 is a dynamic means that will vary based on the current conditions and various advanced notice requirements. The DR Resource Modeler (DRM) 108 within DROMS-RT keeps track of all the available DR Resources, their types, their locations and other relevant characteristics such as response times, ramp-times etc. The DRM 108 also monitors the constraints associated with each resource such as the notification time requirements, number of events in a particular period of time and number of consecutive events. It can also monitor user preferences to determine a “loading order” as to which resources are more desirable for participation in DR events from a customer's perspective and the contract terms and price at which a resource is willing to participate in an event. The DRM 108 also gets a data feed from the client to determine if the client is “online” (i.e. available as a resource) and whether the client has opted-out of the event.

The output from the Resource Modeler 108 is fed into the forecast engine 104. The Forecasting Engine 104 performs short-term forecasts of aggregate load and available load-sheds for individual loads connected to DROMS-RT based on the list of available resources and the participating loads. DROMS-RT 100, by providing a unified view of all DR resources across all programs and optimally dispatching these resources will make the system significantly more efficient. This efficiency gain will bring down the cost of the electricity for customers and will further spur adoption of the technology causing a powerful positive feedback loop.

Historical time-series data from past participation will be used to build a self-calibrated model for each customer that will be able to forecast, shed capacity, ramp time and rebound effects for that customer given the time-of-day, weather and price signal.

The portfolio of dynamic resources is controlled by DROMS-RT to produce pseudo generation per utility ISO signal. The DROMS-RT load forecast model also takes into account customer specific behavior and is able to predict the change in load profile due to the use of specific strategies that the customer might be using to shift the load from a period of high prices to low prices. Such strategies may include pre-cooling a building in anticipation of high prices to reduce the usage during the higher priced events. Such strategies are implicitly ‘learned’ from the load time-series of individual customers. The DROMS-RT load forecast algorithm is also able to predict effects of customer fatigue when the high price events happen repeatedly, back-to-back or if they are too long, by looking at the customer load data. The availability of the individual load forecasts also improve the overall accuracy of the system-level load forecast by combining many different bottom-up sources of data.

The system 100 of the present invention is cost-effective, reliable and stable for accurate real-time forecasting and can be applied in IP based control and communication telemetry devices and can be used in individual residences, apartment buildings, offices, industrial and real-world applications. In addition, the invention can be coupled with recent advances in ruggedized devices to bring down the cost for telemetry devices below <$500.

What is claimed is:

1. A method for individualized forecast of customer load in presence of dynamic pricing signals comprising:
recording the customer's participation history in different demand response events at each customer locations;
segmenting the demand response specific data in a plurality of related time series;
building a self-calibrated model for each customer using the time series;
taking feedback from the time series to predict the changes in customer load profile;
forecasting load usage and load shed as well as error distribution associated with forecast using machine learning and data mining techniques.

2. The method of claim 1 wherein the demand response event specific data includes demand response resources data, its type, its locations, characteristics such as response time, ramp time, utility meter data, user specific data, time series data, seasonality data, price index data, notification time requirement, number of events in a particular period of time and number of consecutive event, user preference to participate in the event, price index and other regression based data.

3. The method of claim 1 wherein demand response specific data is segmented on the basis of seasonality, time of occurrence, price index, temperature and other regression parameters.

4. The method of claim 1 wherein the segmenting techniques used for segmenting the demand response event specific data includes K-mean and fuzzy K-means algorithm.

5. The method of claim 1 wherein pricing signals are variable on current conditions and advanced notice requirements associated with a demand response event.

6. The method of claim 1 wherein the forecasting of load is performed as a function of time of day, weather and price signal.

7. The method of claim 1 wherein the self-calibrated model will be able to forecast shed capacity, ramp time and rebound effect for the customer.

8. The method of claim 1 wherein the pricing signals include cost, reliability, loading order, preference, GHG etc.

9. The method of claim 1 wherein the feedback is provided through machine learning techniques.

10. The method of claim 1 wherein the participation history is collected through advanced metering infrastructures and sensors installed on the grid distribution.

11. The method of claim 1 wherein the machine learning algorithm includes ARIMAX, KNN, SVM or Artificial Neural Network or a combination thereof.

12. A method for individualized forecast of customer load in presence of dynamic price signals comprising:
Collecting a periodic electricity usage data at each customer level;
aggregating the electricity usage data at transformer, feeder and sub-station level;
creating a customer profile for electric load usage with a function of price elasticity, the said price elasticity function is estimated using a machine learning technique;
segmenting the customer electricity usage data in time series using clustering techniques;
forecasting the electricity load usage for each customer and the aggregated load usage at feeders, transformers and substation level.

13. The method of claim 12 wherein the dynamic price signals include price based DR for load forecasting.

14. The method of claim 12 wherein the pricing signals include cost, reliability, loading order, preference, GHG etc.

15. The method of claim 12 wherein the participation history signifies history of participation in past event, strategy for reducing participation in high price event, notification time requirements.

16. The method of claim 12 wherein the profile for individual customer is generated on the basis of electric usage at the end-level.

17. The method of claim 12 wherein the machine learning techniques include ARIMAX, KNN, SVM or Artificial Neural Network or a combination thereof.

18. The method of claim 12 wherein the clustering techniques are used to segment the usage data in similar time series on the basis of seasonality, time of occurrence, price index, temperature and other variables.

19. The method of claim 12 wherein the segmenting techniques used for segmenting the demand response event specific data includes K-means and fuzzy K-means methods.

20. The method of claim 12 wherein the aggregated power load is calculated as the sum of forecast of individual customer.
